(19) United States
(12) Patent Application Publication
(10) Pub. No.: US 2025/0019273 A1
(43) Pub. Date: Jan. 16, 2025

(54) METHOD AND SYSTEM FOR ELECTROCHEMICAL-BASED CARBON CAPTURE AND SEQUESTRATION/VALORIZATION

(71) Applicant: THE BOARD OF TRUSTEES OF THE UNIVERSITY OF ILLINOIS, Urbana, IL (US)

(72) Inventors: Kyle Christopher Smith, Champaign, IL (US); Aniruddh Shrivastava, Sunnyvale, CA (US)

(73) Assignee: THE BOARD OF TRUSTEES OF THE UNIVERSITY OF ILLINOIS, Urbana, IL (US)

(21) Appl. No.: 18/713,023

(22) PCT Filed: Nov. 7, 2022
(86) PCT No.: PCT/US2022/049150

§ 371 Date: May 23, 2024

Related U.S. Application Data
(60) Provisional application No. 63/418,159, filed on Oct. 21, 2022.
(60) Provisional application No. 63/283,332, filed on Nov. 26, 2021.

(51) Int. Cl. C02F 1/461; C02F 101/10; C02F 103/08

(52) U.S. Cl. CPC C02F 1/46109; C02F 2001/46133; C02F 2101/10; C02F 2103/08; C02F 2201/46115; C02F 2201/4612; C02F 2201/4618

(57) ABSTRACT

Aspects of the subject disclosure may include, for example, an electrochemical apparatus, comprising a pair of electrodes each composed of an intercalation host compound (IHC), a separator disposed between the pair of electrodes, and a controller configured to control cycling of the electrochemical apparatus, wherein the pair of electrodes is configured to undergo, during the cycling, reduction-oxidation (redox) reactions in electrolyte solutions that facilitate capturing of carbon dioxide (CO₂) and release of captured CO₂. Additional embodiments are disclosed.

### CROSS REFERENCE TO RELATED APPLICATIONS

This application claims the benefit of and priority to U.S. Provisional Patent Application Ser. No. 63/283,332, filed on Nov. 26, 2021, and U.S. Provisional Patent Application Ser. No. 63/418,159, filed on Oct. 21, 2022. All sections of each of the aforementioned applications are incorporated herein by reference in their entirety.

### FIELD OF THE DISCLOSURE

The subject disclosure generally relates to electrochemical-based capturing and mineralization of carbon dioxide (CO₂).

### BACKGROUND

The mounting evidence supporting the link between CO₂ and climate change is widely accepted. Increased burning of fossil fuels for energy and manufacturing on a global scale has significantly contributed to the problem. Based on one estimate, the atmospheric CO₂ growth rate over the past decade alone has exceeded a hundred times the average rate experienced since the last ice age. Consequently, even an immediate, complete global transition to the use of renewable energy will likely be insufficient to mitigate the present climate crisis.

### BRIEF DESCRIPTION OF THE DRAWINGS

Reference will now be made to the accompanying drawings, which are not necessarily drawn to scale, and wherein:

FIG. 1 is an example graphical representation illustrating, among other things, the aqueous absorption of CO₂ (at thermodynamic equilibrium), as a function of power of hydrogen (pH), using an alkaline electrolyte solution, in accordance with various aspects described herein:

FIG. 2A is a diagram of an example, non-limiting electrochemical power of hydrogen (pH) swing cell system in accordance with various aspects described herein:

FIG. 2B is a diagram of another example, non-limiting electrochemical pH swing cell system in accordance with various aspects described herein:

FIG. 2C shows graphical representations that illustrate the total gas pressure for a proton intercalation material having certain potential versus the corresponding reversible hydrogen electrode (RHE) and reversible oxygen electrode (ROE) in accordance with various aspects described herein:

FIG. 2D shows graphical representations that illustrate Faradaic loss percentage in the limit of vanishing headspace for a proton intercalation material having certain potential versus the corresponding reversible hydrogen electrode (RHE) and reversible oxygen electrode (ROE) in accordance with various aspects described herein:

FIG. 2E shows graphical representations that illustrate total gas pressure for a proton intercalation material having certain potential versus the corresponding reversible hydrogen electrode (RHE) and reversible oxygen electrode (ROE) in accordance with various aspects described herein:

FIG. 2F is a top view (B) of a cell showing valve locations, detailed views of (C) the inlet region of the cell showing symmetric intercalation electrodes sandwiching an ion exchange membrane and (D) valve switching actions, as well as a depiction (E) of the time sequence of cell voltage and salt concentration used to conduct one complete cycle using inset diagrams together with the timing of valve and current switching events controlled automatically, in accordance with various aspects described herein.

FIG. 2G is a schematic of an exemplary, non-limiting integrated direct-air CO₂ capture system facilitated by an alkaline electrochemical pH-swing process using recirculating operation within an electrochemical cell, in accordance with various aspects described herein.

FIG. 2H is a schematic of an exemplary, non-limiting embodiment of an electrochemical CO₂ capture cell using symmetric alkali (ne earth)-ion intercalation electrodes that sandwich different types of anion transmissive separators (where IHC represents an intercalation host compound), in accordance with various aspects described herein.

FIG. 2I is a schematic of an exemplary, non-limiting embodiment of an electrochemical CO₂ capture cell using one alkali (ne earth)-ion intercalation electrode and one electrode that intercalates carbonate and/or bicarbonate while having a separator that is omni-transmissive (where IHC represents an intercalation host compound), in accordance with various aspects described herein.

FIG. 2J is a schematic of an exemplary, non-limiting embodiment of an electrochemical CO₂ capture cell using symmetric (bi)carbonate-ion intercalation electrodes that sandwich different types of cation transmissive separators (where IHC represents an intercalation host compound), in accordance with various aspects described herein.

FIG. 3 depicts an example, non-limiting method in accordance with various aspects described herein; and

FIG. 4 is a block diagram of an example, non-limiting embodiment of a computing environment in accordance with various aspects described herein.

### DETAILED DESCRIPTION

In the coming decades, cost-effective and energy-efficient negative CO₂ emissions solutions, such as systems that capture and sequester the emissions into some form that is benign, stable, and perhaps even useful, will be essential to address the CO₂ that has already been emitted into the environment. Economic feasibility of these solutions is important, given the vast amounts of post-combustion CO₂ that need to be captured and stored/converted.

There currently exist direct-air CO₂ capture systems that extract the gas from gaseous mixtures, such as air (with a global average of about 400 parts per million (ppm) of CO₂) and flue gas. However, the separation processes of these systems have high energy consumption requirements (e.g., many times the thermodynamic minimum energy required to capture CO₂), which make them impractical for widespread adoption. Amine liquid absorbent-based systems, such as aqueous monoethanolamine (MEA) solutions, for instance, involve thermally-driven processes (where heat is needed to liberate captured CO₂ and to regenerate the amine solution), which subjects them to Carnot limits on efficiency. Additionally, electrodialysis-based CO₂ pumps, which leverage a static pH gradient to separate CO₂ from air, use significant amounts of energy to drive gas evolution reactions at high potentials. Further, while electrochemical cell-based CO₂ capture systems—that employ an anion exchange membrane and that utilize an acidic (or near-neutral) electrolyte to effect pH swings—can operate at a generally constant temperature, and thus avoid the Carnot efficiency limit, energy consumption of these systems is nevertheless high, and the membranes and solutions of extreme pH are also expensive.

The subject disclosure describes, among other things, illustrative embodiments of an electrochemical cell system that is capable of capturing CO₂, such as that present in air or flue gases, by leveraging a pH swing in an alkaline (or basic) environment.

As CO₂ is readily absorbed into alkaline electrolyte solutions (i.e., via complexing with a dissociated water molecule and yielding of a carbonate anion, such as according to the equation: CO_{2(g)}+2OH⁻→CO₃²⁻+H₂O), in exemplary embodiments, the system may be configured to exploit such facile absorption (or higher absorption capacity) of CO₂ gas in higher-pH solutions by inducing (e.g., using an electrical power source and without applying thermal energy) a cyclic pH swing in a basic electrolyte (e.g., a potassium hydroxide (KOH) solution, a sodium hydroxide (NaOH) solution, or another type of alkaline electrolyte solution) to facilitate capturing/uptake, and subsequent liberation/release, of CO₂.

In various embodiments, the pH swing cell system may employ Faradaic deionization (FDI) as the electrochemical separations technique, where reduction-oxidation (redox) active ion-intercalation materials with high charge storage capacity and high selectivity are utilized, and where the process is operated within a moderate potential window, thus offering low energy consumption.

In lieu of using chemical reagents to effect the pH swing cell system (such as by adding acid to the alkaline electrolyte solution to neutralize hydroxide ions therein and to decrease the concentration of carbonate ions in water), which can be costly, embodiments of the exemplary system may leverage electrons as the reagent. In various embodiments, the system may employ one or more reversible proton intercalation/de-intercalation electrodes to facilitate electron transfer.

In one or more embodiments, the system can have a symmetric cell configuration that includes a pair of reversible proton intercalation/de-intercalation electrodes along with an ion (e.g., a cation) exchange membrane that separates the two electrodes for efficiency.

In various embodiments, reversible proton intercalation/de-intercalation electrodes may be selected in accordance with an electrochemical stability window. More particularly, a candidate electrode material may be capable of undergoing redox at potentials where an alkaline, H₂O-based electrolyte (in which the electrode is to be operated) is stable with respect to electrolysis of the electrolyte. In other words, and as described in more detail below, a candidate (or ideal) electrode material would permit proton intercalation to occur at a potential (or range of potentials) that is lower than a potential for oxygen gas evolution (i.e., a relatively high potential) and that is higher than a potential for hydrogen gas evolution (i.e., a relatively low potential)—that is, in between the respective potentials at which oxygen and hydrogen gases evolve. In various embodiments, and as described in more detail below, electrochemical pH-swing material(s) may be selected using criteria based on gas evolution equilibria.

In certain embodiments, the reversible proton intercalation/de-intercalation electrodes can include electrodes that are typically utilized in nickel metal hydride (Ni-MH) rechargeable batteries—e.g., a nickel (II) hydroxide [Ni(OH)₂]/nickel oxyhydroxide (or oxide hydroxide) [NiOOH] redox couple, which undergoes a reversible reaction in alkaline media: Ni(OH)₂+OH⁻ [symbol] NiOOH+H₂O+e-, and thus facilitates capturing/release of OH⁻ ions during cycling (as described in more detail herein). NiOOH permits proton intercalation to occur at a potential that is nearer to the oxygen gas evolution potential. It is to be appreciated and understood that alternative proton intercalation/de-intercalation materials may be used in the system, such as metal hydride materials (e.g., Lanthanum-nickel alloy (LaNi₅)), manganese (III) oxyhydroxide (MnOOH), gamma-manganese dioxide (γ-MnO₂), alloys in the ternary system magnesium (Mg)-nickel (Ni)-titanium (Ti), or the like, as described in more detail below. Metal hydrides, for instance, permit proton intercalation to occur at a potential that is nearer to the hydrogen gas evolution potential.

In certain embodiments, the system can have an asymmetric cell configuration that, rather than including a pair of reversible proton intercalation/de-intercalation electrodes, employs only one of such reversible proton intercalation/de-intercalation electrodes on one side of the configuration. Here, and as described in more detail herein, the cell may include, on the opposite side of the configuration, a different electrode material that is capable of absorbing alkali cations of interest (e.g., potassium cations, sodium cations, or other cations (other than protons)) in an alkaline electrolyte solution. By virtue of such a cation intercalation electrode's ability to absorb alkali cations, the system can operate to effect pH swings without a need for an ion exchange membrane.

In exemplary embodiments, the system may be configured to facilitate sequestration or valorization of captured CO₂ via carbonate mineralization with alkaline earths, as described in more detail below.

Leveraging proton intercalation/de-intercalation electrode(s) in an electrochemical pH swing cell enables low-cost, energy-efficient carbon capture and sequestration/valorization. Operating the cell in an alkaline electrolyte solution and inducing alkaline swings in the process can affect the concentration of CO₂ in the solution by orders of magnitude over acidic swings, and with much smaller swings in pH.

The separation factor β_{CO}_{₂}_{/X}, or potential for selective absorption of CO₂ gas, is related to the concentration thereof normalized by gas phase partial pressure in air. With about 80% of air being composed of nitrogen (N₂), about 20% of air being composed of oxygen (O₂), and a concentration of CO₂ of about 400 ppm, a separation process that is highly selective for CO₂ (e.g., about five hundred times more selective than for O₂ and about two thousand times more selective than for N₂) is needed to provide an effective negative emissions process. Whereas other sorbent media provide fairly low selectivity toward CO₂, alkaline media provide much higher selectivity. O₂ and N₂ do not dissociate when dissolved in water, and thus, as given by Henry's Law, their concentrations in any solution (whether acidic or alkaline) is fixed for a given partial pressure. In contrast, CO₂ has a higher propensity to dissolve in water at higher pH levels, and thus the concentration of CO₂ in an alkaline solution, normalized by its gas phase partial pressure, increases dramatically as pH increases, yielding a high separation factor. For instance, at a pH of 10, the separation factor for CO₂ is expected to be over ten thousand, which is greater than that needed for direct-air capture based on the relative concentrations of O₂, N₂, and CO₂ in the atmosphere. In stark contrast, the separation factor in the acidic range can be a thousand times less than that in the alkaline range.

Embodiments that employ a symmetric pH swing cell configuration, with reversible proton intercalation/de-intercalation electrodes separated by a cation exchange membrane (CEM), enable reversible CO₂ sorption in an aqueous solution for direct-air capture and conversion, without a need to generate any gases. Implementing electrochemical separations using FDI, as described herein, provides improved charge storage capacity, lower energy consumption (e.g., a thermodynamic energy efficiency (TEE) of about 50%), and higher ion selectivity, and thus higher rates of CO₂ capture over cells that employ capacitive deionization (i.e., capacitive/pseudocapacitive electrodes) or pressure/temperature-based adsorption processes. This appreciably lowers capital and energy costs, which can dramatically improve the economic feasibility of CO₂ capture, and even enable profitable conversion of the captured CO₂ to valorized products. Additionally, embodiments that utilize an asymmetric cell configuration, with one reversible proton intercalation/de-intercalation electrode and an alkali cation absorbing electrode, eliminate a need for an exchange membrane, which reduces overall manufacturing and maintenance costs.

Embodiments that employ electrodes from used batteries (e.g., Ni-MH rechargeable batteries, etc.) also provide a “second life” for such sources, thereby reducing waste. Further, certain battery-based electrodes, such as NiOOH, provide suitable charge capacities (e.g., 200 milliamp-hours per gram (mAH/g)) that correspond to the specific sorption capacity for CO₂ and can undergo redox reactions in a manner that allows for higher-rate CO₂ capture. This enables the cell configurations to be smaller and less complex, which also reduces capital costs.

In various contexts herein, mention or use of pH may refer to dissolved proton concentration.

One or more aspects of the subject disclosure include an electrochemical apparatus, comprising a pair of electrodes each composed of an intercalation host compound (IHC), a separator disposed between the pair of electrodes, and a controller configured to control cycling of the electrochemical apparatus, wherein the pair of electrodes is configured to undergo, during the cycling, reduction-oxidation (redox) reactions in electrolyte solutions that facilitate capturing of carbon dioxide (CO₂) and release of captured CO₂.

One or more aspects of the subject disclosure include an electrochemical cell, comprising a first electrode composed of a first intercalation host compound (IHC), a second electrode composed of a second IHC, and a control circuit configured to manage cycling of the electrochemical cell, wherein the first electrode and the second electrode undergo, in various stages of the cycling, reduction-oxidation (redox) reactions in an alkaline electrolyte solution that facilitate dissolution of carbon dioxide (CO₂) and liberation of captured CO₂.

One or more aspects of the subject disclosure include a method for operating an electrochemical cell having a first electrode and a second electrode. The method may comprising, in a first cycle of the electrochemical cell, providing a current to, or a potential difference across, the first electrode and the second electrode, and causing a first alkaline electrolyte solution to flow through at least a portion of the electrochemical cell such that the first electrode and the second electrode undergo reactions, resulting in super-saturation in dissolved inorganic carbon (DIC) in the first alkaline electrolyte solution or resulting in an alkaline power of hydrogen (pH) swing in the first alkaline electrolyte solution that facilitates dissolution of carbon dioxide (CO₂) into the first alkaline electrolyte solution.

Other embodiments are described in the subject disclosure.

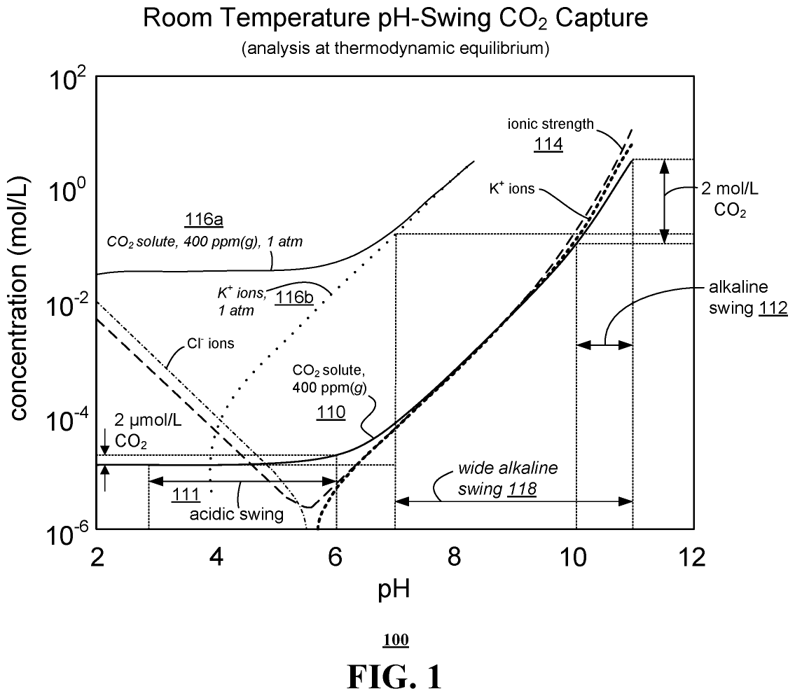

FIG. 1 is an example graphical representation 100 illustrating, among other things, the aqueous absorption of CO₂ (at thermodynamic equilibrium), as a function of pH, using a KOH-based electrolyte, in accordance with various aspects described herein.

As may be apparent from FIG. 1, there are significant benefits of using alkaline pH swings for direct-air CO₂ capture. Particularly, in a case where CO₂ is dissolved in air at about 400 ppm (reference number 110), about 2 mol-CO₂/L is reversibly absorbable over an alkaline pH range from about 10 to about 11 without precipitating compounds, such as potassium carbonate (K₂CO₃) or potassium bicarbonate (KHCO₃). In contrast, only 2 μmol-CO₂/L is accessible over an acidic pH range from about 1 to about 5.5-6 (reference number 111). Relative to electrochemical CO₂ capture in an acidic solution, therefore, an alkaline-based process that employs FDI, as described herein, can enhance CO₂ capture productivity by over a thousand times by exploiting its million-fold higher capacity for CO₂ absorption. This can translate to order-of-magnitude reductions in capital and energy expense. Additionally, having carbonate (CO₃²⁻) ions as the major charge carriers at high pH levels makes it possible to valorize the captured CO₂, as described in more detail herein.

As depicted in FIG. 1, the minimum ionic strength (reference number 114) expected during alkaline cycling (e.g., 0.1 mol/L) is orders of magnitude higher than that expected during acidic cycling (e.g., 2 μmol/L), yielding higher conductivity and rate capability on the basis of ohmic resistance. This increased CO₂ absorption capacity and rate capability can be leveraged for higher productivity and reduced costs to capture greater amounts of CO₂. Depending on the cell configuration (e.g., symmetrical or asymmetrical, as described herein) only a single (or no) ion exchange membrane is needed, which can further reduce system complexity and costs.

As shown by reference numbers 116a and 116b pertaining to 1 standard atmosphere (atm), implementing a wider alkaline pH swing (118) from about 11 to about 7 (or to a pH that is within a threshold above 7, such that the pH swing cell is operated, for example, at its maximal limit as permitted by thermodynamics) enables similar amounts of pure CO₂ to be released at 1 atm after being absorbed at 400 ppm at partial pressure (110). This can potentially reduce or eliminate a need for a downstream mechanical compressor for compressing captured CO₂ to higher pressures, which may otherwise be required to release CO₂ drawn/separated at partial pressure. This can also increase the purity of CO₂ recovered during its liberation from alkaline solution.

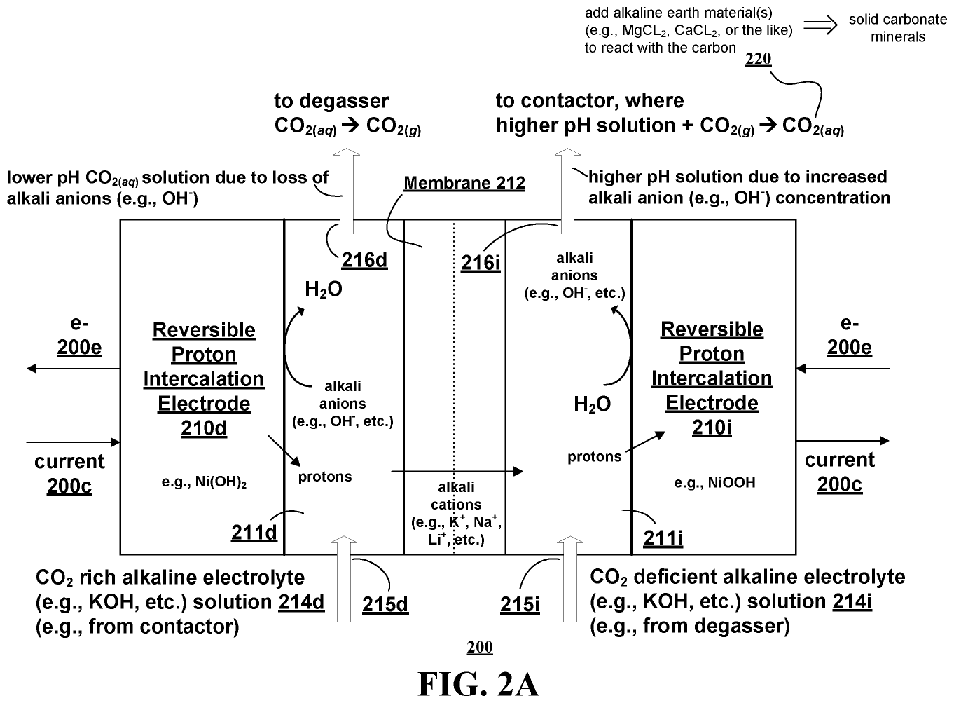

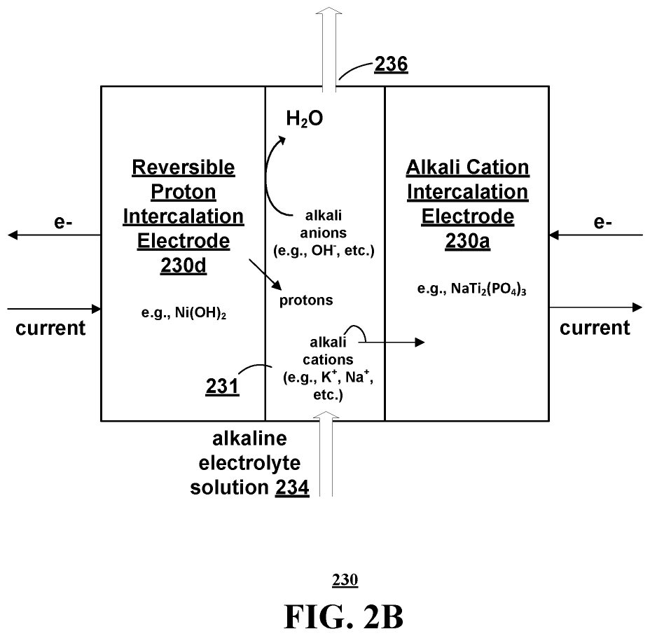

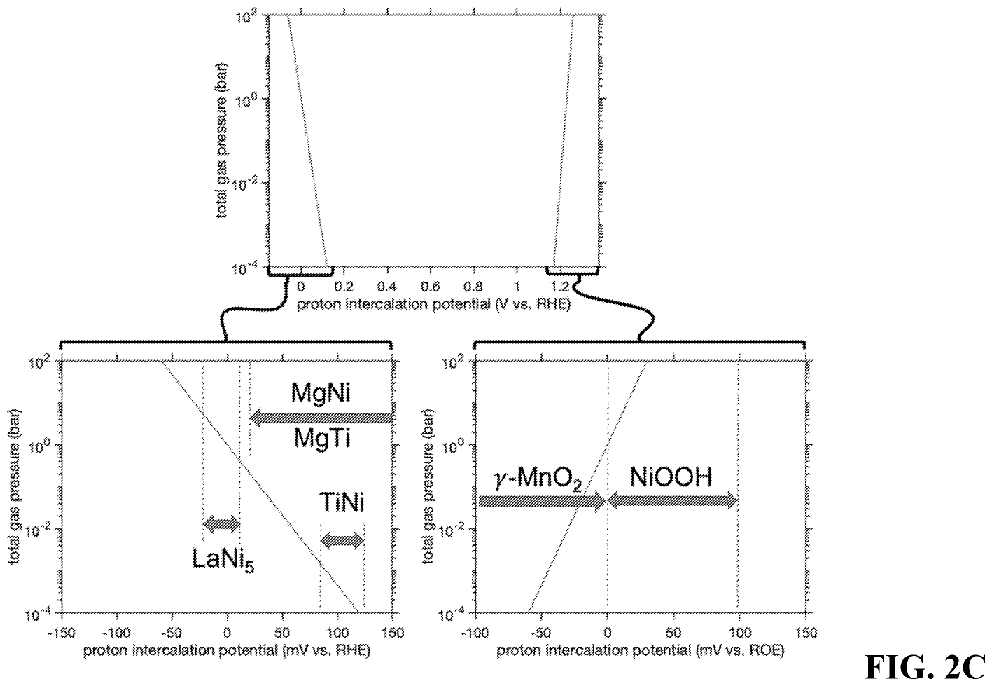

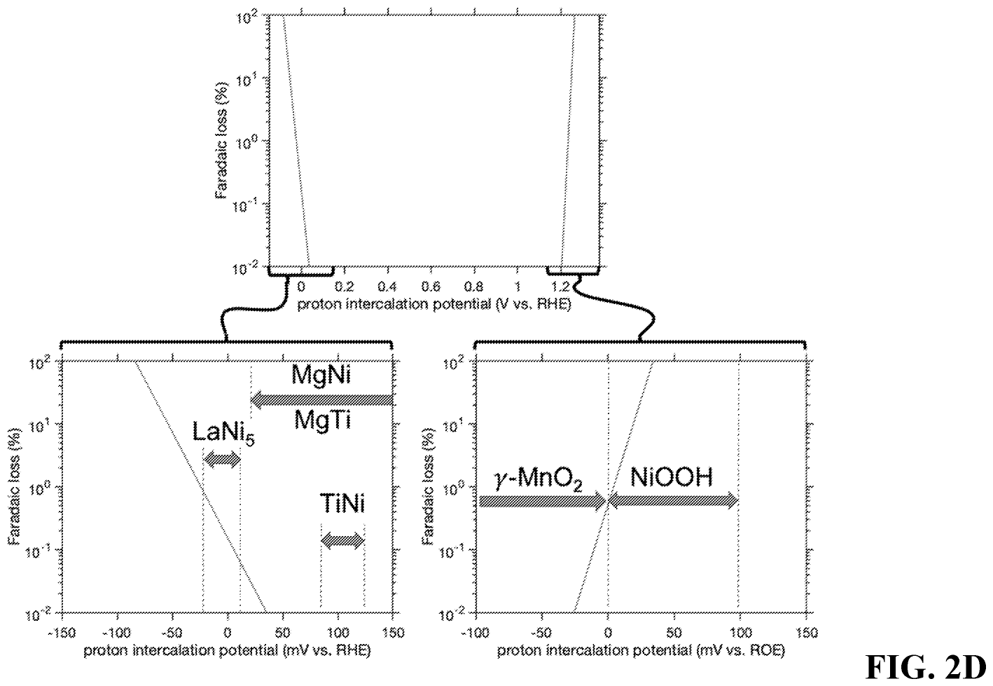

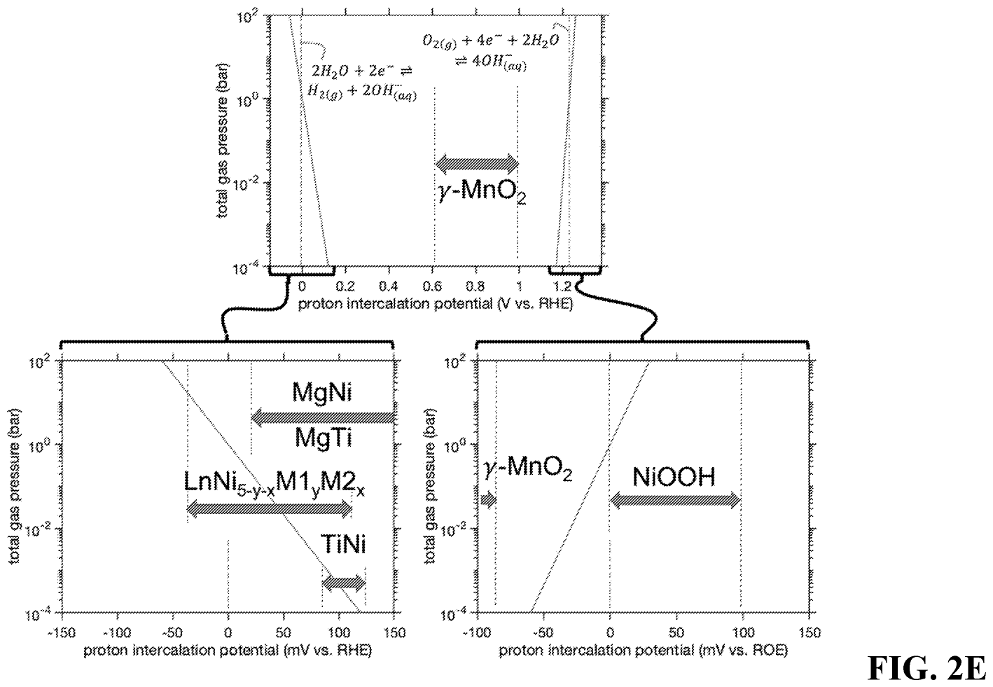

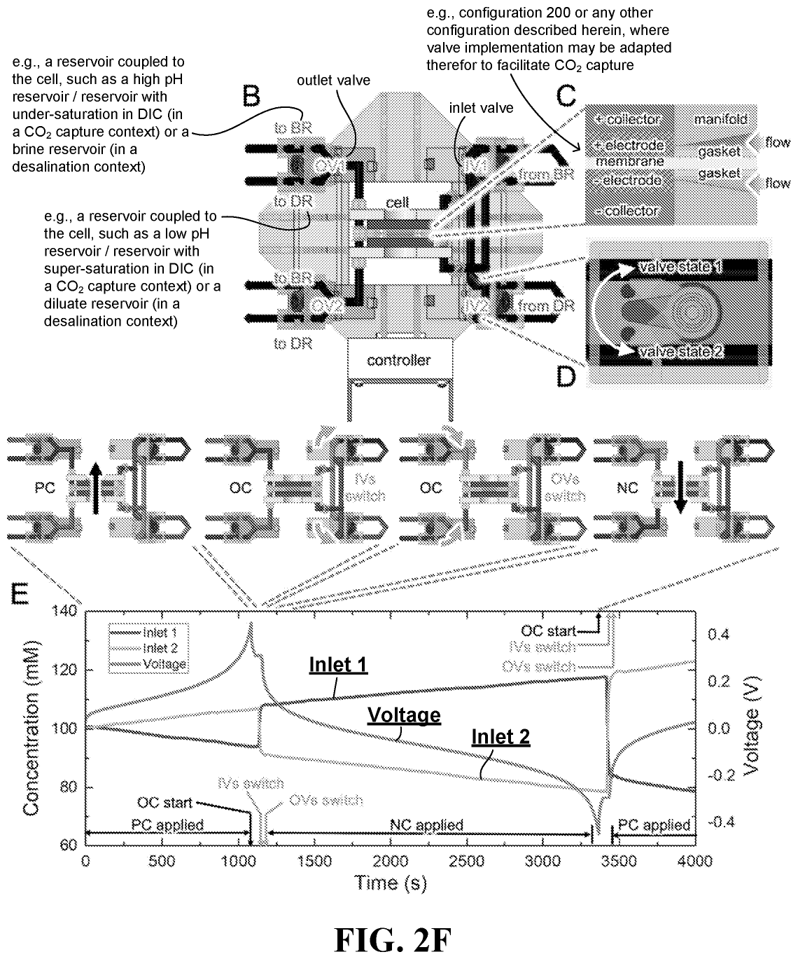

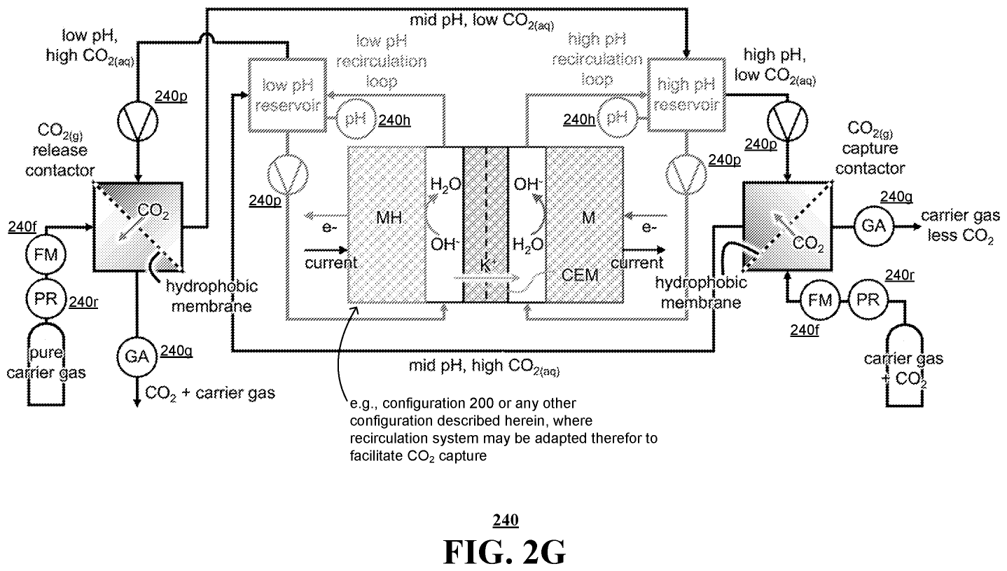

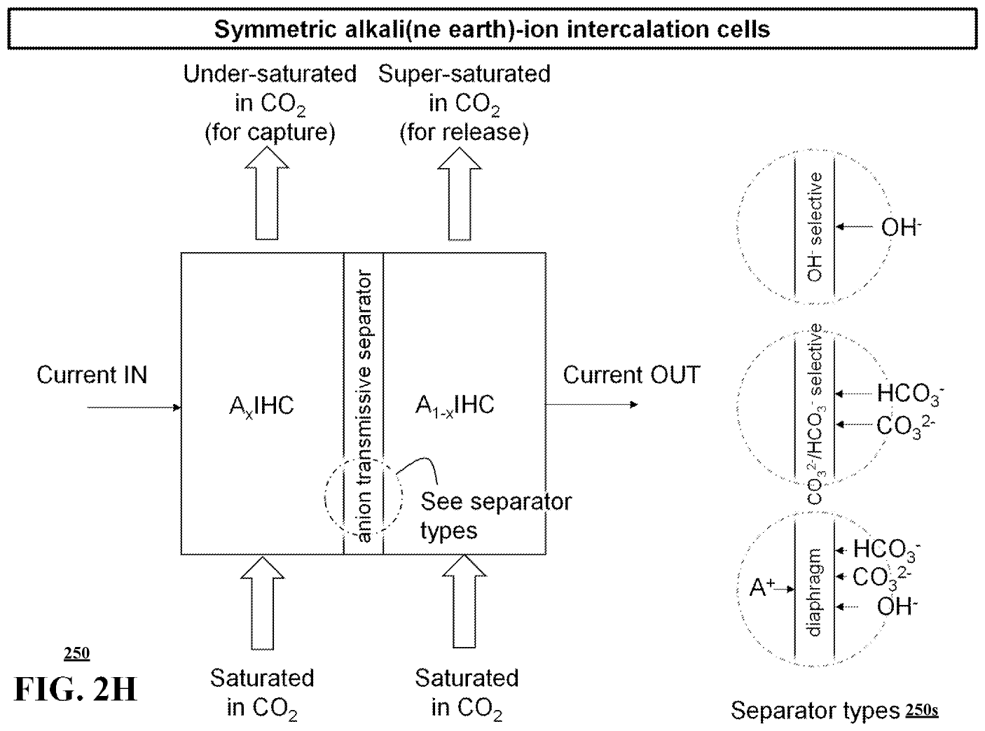

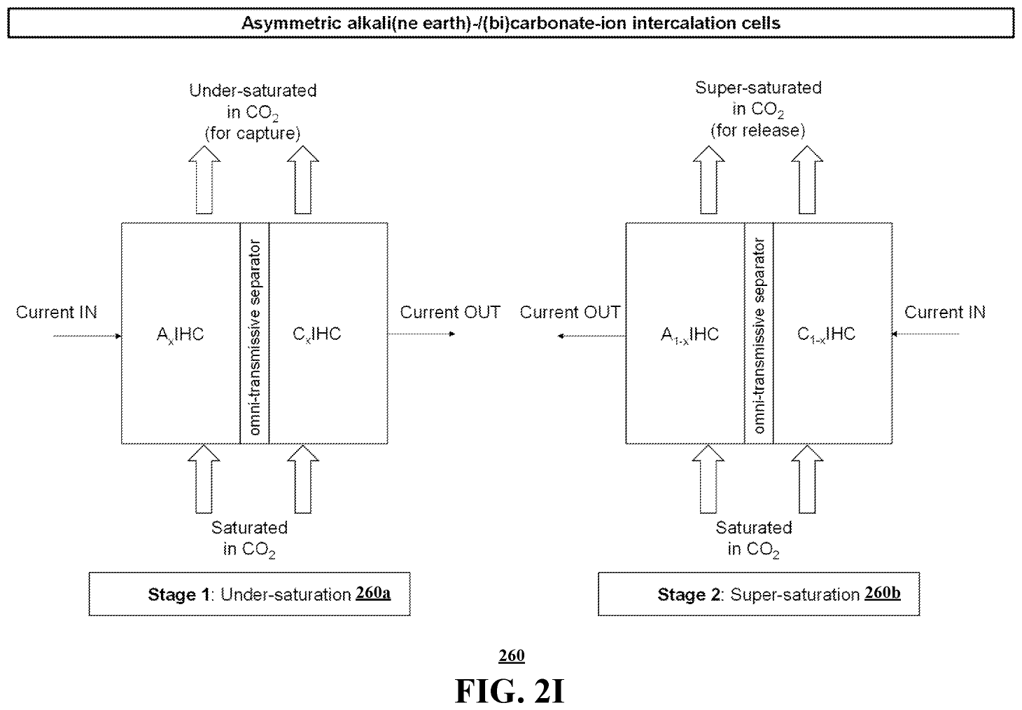

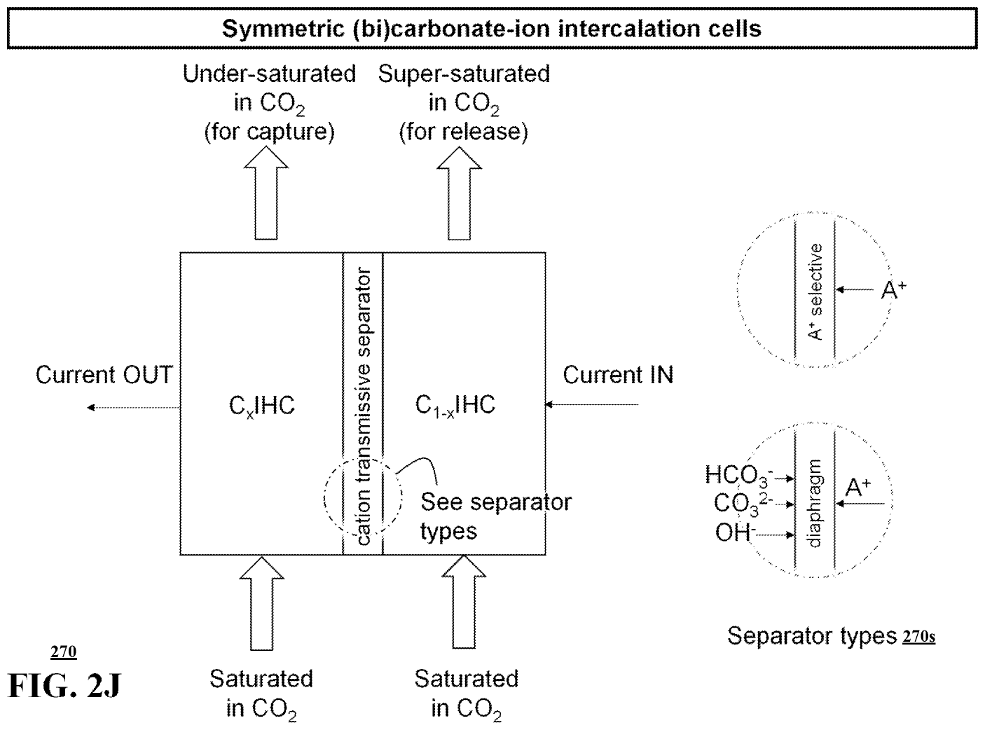

FIG. 2A is a diagram of an example, non-limiting electrochemical pH swing cell system 200, during operation in a cell cycle, in accordance with various aspects described herein. In exemplary embodiments, the system 200 may be configured to facilitate reversible Faradaic electrosorption reactions to consume and produce OH⁻ anions in an alkaline solution without gas generation. As depicted, the system 200 can have a symmetric cell configuration that includes a pair of reversible proton intercalation/de-intercalation electrodes 210d and 210i along with a membrane 212—e.g., a cation exchange membrane (CEM)—therebetween. In various embodiments, the reversible proton intercalation/de-intercalation electrodes 210d and 210i may be configured to undergo redox reactions to facilitate the transfer of electrons 200e.

In exemplary embodiments, the system 200 may be integrated with CO₂ feed and products streams. In certain embodiments, the system 200 may be configured with an external electrolyte circuit—e.g., an automated fluid control circuit—configured to recirculate electrolytes (alkaline electrolyte solutions 214d and 214i) to/from respective storage tanks. For example, as shown in FIG. 2A, the system may include compartments 211d and 211i configured with cell inlets 215d and 215i and outlets 216d and 216i operably coupled to the tanks.

In various embodiments, the system 200 may be operably coupled to a contactor tank (including, e.g., a bubbler, a packed column, a hollow-fiber membrane, or the like) for facilitating absorption of CO₂ in influent CO₂-rich air into a CO₂ deficient alkaline electrolyte solution 214i (e.g., a KOH-based electrolyte solution, an NaOH-based electrolyte solution, or another basic electrolyte solution). In certain embodiments, the system 200 may additionally, or alternatively, be coupled to a degasser tank for facilitating release of pure CO₂ gas from a CO₂ rich alkaline electrolyte solution 214d. Although not shown, an output of the contactor can be operably coupled to inlet 215d of the system 200 to provide the CO₂ rich alkaline electrolyte solution 214d, and an output of the degasser can be operably coupled to inlet 215i of the system 200 to provide the CO₂ deficient alkaline electrolyte solution 214i, thereby providing a closed loop system. In some embodiments, the system 200 may alternatively be open to permit injection/insertion of alkaline earth materials (as described in more detail below).

In various embodiments, the system 200 may include gas pressure regulator(s), pressure transducer(s), vacuum pump(s), and/or other component(s) integrated or operably coupled with the respective tanks to enable flow control based on pressure. In some embodiments, the system 200 may include one or more components configured to measure ion conductivity at cell inlets/outlets 215d, 215i, 216d, and/or 216i. In one or more embodiments, the system 200 may include (e.g., in-line) pH sensors configured for measuring the extent of pH swings in the cell, and may perform cell control functions based on the pH measurements. See, e.g., FIG. 2G, described in more detail below.

Although not shown in FIG. 2A, the system 200 may include an electrical power source that provides an adjustable potential difference between the two electrodes 210d and 210i to drive current 200c. In certain embodiments, the system 200 may include potentiostat(s) for controlling electrochemical cycling.

In one or more embodiments, the system 200 may be configured to force flow of electrolytes through the electrodes 210d and 210i. In some embodiments, one or more (e.g., each) of the electrodes 210d and 210i may be configured as flow-through electrodes that permit electrolytes to flow through pores thereof. In alternate embodiments, one or more (e.g., each) of the electrodes 210d and 210i may be configured for flow that is adjacent to (or beside) the electrodes.

CO₂ dissolves as carbonate and bicarbonate ions in water, and its solubility increases with increasing pH. Therefore, an appreciable change in pH of a feed stream containing dissolved CO₂ (e.g., alkaline electrolyte solution 214d) can be used to obtain pure CO₂ gas by shifting the pH from higher to lower values.

To enable FDI for alkaline-based CO₂ capture, materials that can reversibly consume/produce OH⁻ ions in alkaline solution may be needed. For instance, a β-phase Ni(OH)₂/NiOOH redox couple can be used as the reversible proton intercalation/de-intercalation electrodes 210d and 210i. In various embodiments, commercial Ni(OH)₂ electrodes may be obtained by disassembling one or more Ni-MH batteries. For instance, NiOOH electrodes supported on intact current collectors may be extracted from one or more Ni-MH batteries. This recycling-based approach can significantly reduce capital expenses and, consequently, the levelized cost of CO₂ capture. In alternate embodiments, electrodes can be slurry casted using β-NiOOH nanopowder synthesized from commercial chemicals via coprecipitation or the like. Nickel hydroxide electrodes exhibit high gravimetric charge storage capacities (e.g., between 135 to 250 mAh/g) and volumetric capacity (e.g., up to 550 mAh/cm³ in 6M KOH), which can prove useful for inducing large pH swings in alkaline electrolytes, such as the electrolytes 214d and 214i. Further, unlike metal hydride electrodes, NiOOH/Ni(OH)₂ electrodes are not susceptible to self-discharge by gas release, thus assuring their efficient operation. Given that the potential of NiOOH electrodes is near the gas evolution potential of oxygen, in some embodiments, the electrodes 210d and 210i may be alloyed with other transition metals to reduce electrode potential and oxygen evolution parasitic current, which can provide improved electrode redox potential and performance.

For purposes of illustration only, the following describes certain aspects of the operation of the system 200 in which Ni(OH)₂/NiOOH redox couple electrodes are utilized as the reversible proton intercalation/de-intercalation electrodes 210d and 210i. It is to be appreciated and understood that the system 200 can operate in a similar manner with redox couple electrodes 210d and/or 210i that are composed of other materials, as described in more detail below.

During operation of the system 200 in the cycle shown in FIG. 2A, the NiOOH electrode 210i may become electrochemically reduced to reversibly form Ni(OH)₂ as a result of proton intercalation—where protons react with the NiOOH electrode 210i. Here, H₂O molecules in the alkaline electrolyte solution 214i (flown through the compartment 211i corresponding to the NiOOH electrode 210i) may dissociate, yielding OH⁻ ions, which increases the pH of the alkaline electrolyte solution 214i and facilitates dissolution of CO₂(g) as (bi)carbonate ions into the alkaline electrolyte solution 214i. In contrast, electrochemical oxidation occurs in the Ni(OH)₂ electrode 210d to reversibly form NiOOH as a result of proton de-intercalation—where protons are released by the Ni(OH)₂ electrode 210d into the alkaline electrolyte solution 214d. Here, the protons may combine with OH⁻ ions in the alkaline electrolyte solution 214d (having a large concentration of dissolved CO₂ in the form of carbonates and bicarbonates and flown through the compartment 211d corresponding to the Ni(OH)₂ electrode 210d) to yield H₂O molecules. When the pH is reduced during oxidation of Ni(OH)₂, the CO₂ dissolution equilibrium may shift to release CO₂(g) at the outlet, due to the lower solubility of HCO³⁻/CO₃²⁻. The CEM serves the role of blocking the transfer of alkaline anions, such as OH⁻, from the compartment 211d to the compartment 211i, which may result in OH⁻ ions becoming depleted in the alkaline electrolyte solution 214d, thus reducing its pH, and may result in the concentration of OH⁻ ions in the alkaline electrolyte solution 214i to rise, thus increasing its pH.

Although not shown, in exemplary embodiments, the system 200 can be configured to switch the two streams of alkaline electrolyte solutions in a subsequent cycle, adjust the potential difference between the two electrodes 210d and 210i (such as by reversing the polarity and/or increasing or decreasing the potential difference), repeat the process to capture/release more CO₂, and so on.

In various embodiments, there may be a range of pH—i.e., an upper pH limit and a lower pH limit—over which it is feasible to operate the cycles. In one or more embodiments, the system 200 may effect an alkaline pH swing that spans such a range. In certain embodiments, the upper pH limit may be defined/dictated based on the solubility of alkali cations (e.g., K⁺, Na⁺, etc.)—for example, the upper pH limit may be about 13, about 14.6, etc. Too high of a pH may facilitate precipitation of compounds into the cell, such as potassium carbonates or bicarbonates, sodium carbonates or bicarbonates, etc. In some embodiments, the lower pH limit may be defined/dictated based on the abundance of alkali cations (e.g., K⁺, Na⁺, etc.) and/or protons in the alkaline electrolyte solution—for example, the lower pH limit may be about 10, about 11, etc. In exemplary embodiments, the lower pH limit may be defined such that alkali cations (and not protons) are able to cross the CEM.

In various embodiments, the system 200 may operate at a fixed potential or, alternatively, at a fixed current (which may provide for more efficient cycling). For instance, in certain embodiments, the system 200 may be configured to set and maintain the potential difference to a first value for one stage of the electrochemical cell cycling, set and maintain the potential difference to a second value for a subsequent stage of the electrochemical cell cycling, set and maintain the potential difference to the first value (or a different value) for a next stage of the electrochemical cell cycling, and so on. In any of the cycles, as the current achieved decays and reaches a certain predefined switch level, the system 200 may switch the potential to an opposite polarity so as to regenerate the cell and induce the reverse process to occur therein.

FIG. 2B is a diagram of an example, non-limiting electrochemical pH swing cell system 230, during operation in a cell cycle, in accordance with various aspects described herein. In one or more embodiments, the system 230 may (e.g., similar to the system 200 of FIG. 2A) be configured to facilitate reversible Faradaic electrosorption reactions to consume and produce OH⁻ anions in an alkaline electrolyte solution without gas generation. As depicted in FIG. 2B, the system 230 can have an asymmetric cell configuration that includes a reversible proton intercalation/de-intercalation electrode 230d (e.g., similar to the reversible proton intercalation/de-intercalation electrode 210d or 210i) and an alkali cation intercalation electrode 230a. The system 230 may include a compartment 231 (e.g., similar to compartment 211d or 211i) through which alkaline electrolyte solutions, such as the alkaline electrolyte solution 234 in the cycle shown, may flow during electrochemical cycling and facilitate redox reactions at the electrodes 230d and 230a.

In contrast to the system 200, the system 230 may not include an exchange membrane disposed between the electrodes 230d and 230a. In certain embodiments, the system 230 may nevertheless include a separating layer, such as a non-selective separator (not shown), that facilitates transmission of ions in an electrolyte solution (e.g., without restraint) in the compartment 231. In alternate embodiments, the system 230 may not include any such separating layer.

Although not shown, the system 230 may (e.g., similar to the system 200 of FIG. 2A) be operably coupled to a contactor tank and/or a degasser tank, and may be configured with an external electrolyte circuit for recirculating alkaline electrolyte solutions to/from the tanks(s) (as well as, for example, switching cycles of the system 230). In one or more embodiments, the system 230 may include various components needed for operation of the cell, such as, for example, gas pressure regulator(s), pressure transducer(s), vacuum pump(s), ion conductivity measurement device(s), pH sensor(s), electrical power source(s) (e.g., for providing adjustable potential differences to drive current through the electrodes 230d and 230a), potentiostat(s), and/or the like. In some embodiments, one or more (e.g., each) of the electrodes 230d and 230a may be configured as flow-through electrodes that permit electrolytes to flow through pores thereof. In alternate embodiments, one or more (e.g., each) of the electrodes 230d and 230a may be configured for flow adjacent to (or beside) the electrodes.

In exemplary embodiments, the alkali cation intercalation electrode 230a may be capable of absorbing alkali cations of interest (e.g., potassium cations, sodium cations, or other cations (other than protons)) in an alkaline electrolyte solution (e.g., KOH, NaOH, or another basic electrolyte solution). By virtue of such a cation intercalation electrode's ability to absorb alkali cations, the system 230 can operate to effect pH swings without a need for an ion exchange membrane.

The alkali cation intercalation electrode 230a can be composed of any suitable material that is capable of absorbing alkali cations as part of redox reactions. For example, the alkali cation intercalation electrode 230a can be composed of one or more inorganic redox-active intercalation host compounds. For instance, the alkali cation intercalation electrode 230a can be composed of the alkaline-stable, Na Super Ionic Conductor (NaSICON) material NaTi₂(PO₄)₃ (NTP), such as that used in Na-ion batteries. As another example, the alkali cation intercalation electrode 230a can be composed of one or more polymeric redox-active compounds.

For purposes of illustration only, the following describes certain aspects of the operation of the system 230 in which an Ni(OH)₂/NiOOH electrode is utilized as the reversible proton intercalation/de-intercalation electrode 230d and NaTi₂(PO₄)₃ is utilized as the alkali cation intercalation electrode 230a. It is to be appreciated and understood that the system 230 can similarly operate with electrodes 230d and/or 230a that are composed of other materials.

During operation of the system 230 in the cycle shown in FIG. 2B, electrochemical oxidation occurs in the Ni(OH)₂ electrode 230d to reversibly form NiOOH as a result of proton de-intercalation—where protons are released by the Ni(OH)₂ electrode 230d into the alkaline electrolyte solution 234. Here, the protons may combine with OH⁻ ions in the alkaline electrolyte solution 234 (which, in the cycle shown, may have a large concentration of dissolved CO₂ in the form of carbonates and bicarbonates) to yield H₂O molecules. In contrast, the NaTi₂(PO₄)₃ electrode 230a may undergo reduction, in which alkali cations (e.g., K⁺ ions in a case where the alkaline electrolyte solution 234 is KOH-based, Na⁺ ions in a case where the alkaline electrolyte solution 234 is NaOH-based, etc.) are intercalated. The net effect is a decrease in concentration of OH⁻ ions in the solution, and thus a decrease in overall pH of the solution. When the pH is reduced as such, the CO₂ dissolution equilibrium may shift to release CO₂(g) at the outlet 236.

It is to be appreciated and understood that FIG. 2B shows an operation of the system 230 in which only one stream of alkaline electrolyte solution is generated during a given stage of a cycle—here, a mode in which the pH of an alkaline electrolyte solution is decreased. In some embodiments, the system 230 may be capable of operating in one or more subsequent stages. For example, the system 230 may effect a switching operation (which may include, for example, switching a potential difference between the electrodes 230d and 230a) of the cell such that an alkaline electrolyte solution that is deficient in CO₂ (rather than rich in CO₂) may flow into compartment 231. In this case, the electrode 230d (now in the form of NiOOH) may become electrochemically reduced to reversibly form Ni(OH)₂ as a result of proton intercalation—where protons react with the electrode 230d. Here, H₂O molecules in the alkaline electrolyte solution (flown through the compartment 231) may dissociate, yielding OH⁻ ions. In contrast, the NaTi₂(PO₄)₃ electrode 230a may undergo oxidation, in which alkali cations are released. The net effect is an increase in concentration of OH⁻ ions in the solution, and thus an increase in overall pH of the solution. The increase in pH of the alkaline electrolyte solution facilitates dissolution of CO₂(g) as (bi)carbonate ions into the alkaline electrolyte solution.

In this way, a membrane-free electrochemical pH swing cell can be provided for CO₂ capture and sequestration/valorization, which can reduce capital costs, given that exchange membranes can be expensive.

As discussed briefly above, embodiments described herein may facilitate a CO₂ capture process by controlling pH of an alkaline solution via proton intercalation reactions inside of a host material that undergoes reversible electrochemical reduction, which result in the simultaneous dissociation of water and yielding of OH⁻ ions in the solution:

$$M + {H}_{2} O + {e}^{-} ⇌ MH + {OH}_{( a q )}^{-} at potential {E}_{M / M H} . \qquad ( Eq . l )$$

Here, M and MH are the oxidized and reduced forms of a proton intercalation material of interest. However, side reactions caused by electrolysis of water may occur to certain degrees depending upon the magnitude of the potential applied at the electrode of interest. These reactions may include O₂ and H₂ evolution reactions that (for purposes of illustration) can be assumed to be reversible:

$${O}_{2 ( g )} + 4 {e}^{-} + 2 {H}_{2} O ⇌ 4 {OH}_{( a q )}^{-} at potential {E}_{O R R / O E R} ; \qquad ( Eq . 2 )$$

$$2 {H}_{2} O + 2 {e}^{-} ⇌ {H}_{2 ( g )} + 2 {OH}_{( a q )}^{-} at potential {E}_{H E R / H O R} . \qquad ( Eq . 3 )$$

The impact of these side reactions on the operation of an alkaline electrochemical pH-swing process may be quantified by assuming thermodynamic equilibrium, such that the potentials for the preceding reactions are identical: E_{M}=E_{ORR/OER}=E_{HER/HOR}. Accordingly, for a given pH and a certain standard potential for the proton intercalation reaction (E_{M}⁰), the associated O₂ and H₂ gas pressures that occur at equilibrium may be determined using the Nernst equation for the abovementioned reactions:

$$E = {E}^{0} + \frac{R T}{n F} ln ( \frac{{a}_{Ox}}{{a}_{R e d}} ) , \qquad ( Eq . 4 )$$

where E⁰, n, a_{Ox}, and a_{Red} are respectively the standard potential, number of electrons transferred, oxidized species activity, and reduced species activity for the reaction of interest. RT/F is the thermal voltage (e.g., equal to 25.9 millivolts (mV) at 300 Kelvin (K)). Neglecting activity variations of water molecules and assuming ideal liquid and gas solutions, the following are respective potentials for proton intercalation, O₂ evolution, and H₂ evolution:

$${E}_{M / M H} = {E}_{M / M H}^{0} - \frac{R T}{F} ln ( 10 ) ( pH - 14 ) ; \qquad ( Eq . 5 )$$

$${E}_{O R R / O E R} = {E}_{O R R / O E R}^{0} + \frac{R T}{F} ln ( \frac{1}{4} ln ( \frac{{p}_{{O}_{2}}}{{p}^{0}} ) ) - \frac{R T}{F} ln ( 10 ) ( pH - 14 ) ; \qquad ( Eq . 6 )$$

$${E}_{H E R / H O R} = {E}_{H E R / H O R}^{0} + \frac{R T}{F} ln ( \frac{1}{2} ln ( \frac{{p}^{0}}{{p}_{{H}_{2}}} ) ) - \frac{R T}{F} ln ( 10 ) ( pH - 14 ) . \qquad ( Eq . 7 )$$

Using the electrochemical equilibrium relation (E_{M}=E_{ORR/OER}=E_{HER/HOR}), the pressure of O₂ and H₂ gas at equilibrium can be determined to be independent of pH:

$${p}_{{O}_{2}} = {p}^{0} exp ( 4 ( {E}_{M / M H}^{0} - {E}_{O R R / O E R}^{0} ) F / RT ) ; \qquad ( Eq . 8 )$$

$${p}_{{H}_{2}} = {p}^{0} exp ( - 2 ( {E}_{M / M H}^{0} - {E}_{H E R / H O R}^{0} ) F / RT ) . \qquad ( Eq . 9 )$$

FIG. 2C shows graphical representations that illustrate the total gas pressure for a proton intercalation material having certain potential versus the corresponding reversible hydrogen electrode (RHE) and reversible oxygen electrode (ROE). Values of potential for different proton intercalation materials are shown for LaNi₅, MgNi, MgTi, and TiNi hydride reactions and for γ-MnO₂ and NiOOH protonation reactions. As shown in FIG. 2C, the aforementioned pressures of O₂ and H₂ gas at equilibrium enable determination of the extent to which the respective gas evolution reactions will occur as a function of the specific type of proton intercalation material used to effect a pH swing. FIG. 2C indicates that there are various electrode materials that can be employed for electrochemical pH-swing-based CO₂ capture, including both the positive (NiOOH) and negative (LaNi₅) electrodes used in the ubiquitous nickel/metal-hydride battery and alloy variants thereof. Notably, LaNi₅ shows gas pressure substantially smaller than NiOOH, and thus may be more favorable than NiOOH in certain embodiments. Furthermore, other materials may, in certain embodiments, outperform both of these electrode materials on the basis of reducing or minimizing gas pressure, including alloys in the ternary system Mg—Ni—Ti as well as γ-MnO₂.

The aforementioned pressures of O₂ and H₂ gas at equilibrium can also be used to quantify the amount of electric charge Qᵢ constituted by the generation of a gas i in the headspace volume Vₕₛ of an enclosed reactor and dissolved in the aqueous electrolyte volume V_{liq}:

$${Q}_{i} = ( n / {s}_{i} ) F {p}_{i} ( {V}_{h s} / RT + {K}_{i} {V}_{liq} ) , \qquad ( Eq . 10 )$$

where sᵢ and Kᵢ are the stoichiometric coefficient and Henry's Law constant associated with generation of gas i. The desired amount of charge transfer Q_{M/MH} during an electrochemical pH-swing half-cycle step can also be quantified based on the desired change in counter-cation (e.g., K⁺ or Na⁺) concentration Δc₊:

$${Q}_{M / M H} = F Δ {c}_{+} {V}_{liq} . \qquad ( Eq . 11 )$$

Normalizing Qᵢ by Q_{M/MH} yields a dimensionless Faradaic efficiency loss metric Δη_{F,i} representing the fraction of charge lost to gas evolution reactions at equilibrium:

$$Δ {η}_{F , {O}_{2}} = 4 exp ( 4 ( {E}_{M / M H}^{0} - {E}_{ORR / OER}^{0} ) F / RT ) ( {V}_{h s} / {V}_{l i q} \cdot {p}_{0} / RT / Δ {c}_{+} + {K}_{{O}_{2}} {p}_{0} / Δ {c}_{+} ) ; \qquad ( Eq . 12 )$$

$$Δ {η}_{F , {H}_{2}} = 2 exp ( - 2 ( {E}_{M / M H}^{0} - {E}_{H E R / HOR}^{0} ) F / RT ) ( {V}_{h s} / {V}_{l i q} \cdot {p}_{0} / RT / Δ {c}_{+} + {K}_{{H}_{2}} {p}_{0} / Δ {c}_{+} ) . \qquad ( Eq . 13 )$$

FIG. 2D shows graphical representations that illustrate Faradaic loss percentage in the limit of vanishing headspace (Vₕₛ/V_{liq}→0) for a proton intercalation material having certain potential versus the corresponding reversible hydrogen electrode (RHE) and reversible oxygen electrode (ROE). Values of potential for different proton intercalation materials are shown for LaNi₅, MgNi, MgTi, and TiNi hydride reactions and for γ-MnO₂ and NiOOH protonation reactions. The corresponding Faradaic loss is shown in FIG. 2D as a function of proton intercalation potential, overlaid with the same material classes as in FIG. 2C. As can be seen in FIG. 2D, all materials shown (with the exception of NiOOH) may be cyclable over the majority of their state-of-charge range while doing so with Faradaic losses smaller than 1%, with alloys in the ternary Mg—Ni—Ti system showing Faradaic losses smaller than 0.1%. Embodiments described herein that employ such materials can thus enable electrochemical CO₂ capture facilitated by a pH swing. As can also be seen in FIG. 2D, NiOOH electrodes may need to be cycled over a limited potential range to control Faradaic loss via O₂ evolution. It is to be noted, however, that the analysis is performed assuming thermodynamic reversibility of the associated reactions, where, in practice, such a condition may be realized only when O₂ evolution (OER) and recombination (ORR) is perfectly catalyzed. Further, in a case where losses are larger when a finite headspace volume is included in the system, such headspace volume may be reduced or minimized in the system design.

In one or more embodiments, electrode materials may be prepared from LaNi₅, NiOOH, and MnO₂ by extracting material from commercial NiMH and Zn/MnO₂ batteries. Electrolytic MnO₂ and LaNi₅ alloys may also be acquired from commercial sources. These raw materials may be tested or used in either or both pristine and modified forms. Modified forms may be prepared with the aid of planetary ball milling to reduce primary particle size and to alloy with additives to increase charge-storage capacity (e.g., Bi₂O₃ with MnO₂) and to control proton intercalation potential (e.g., Mn and Al with LaNi₅). Synthesis of other materials may aim to selectively poison active sites in NiOOH materials by leveraging catalysis knowledge. The crystal structure, composition, and morphology of electrode materials may be characterized using X-ray diffraction (XRD), energy dispersive X-ray spectroscopy (EDS), and scanning electron microscopy (SEM). X-ray photoelectron spectroscopy (XPS) may also be used for characterizations.

In one or more embodiments, proton intercalation materials may be incorporated into porous electrodes by slurry casting. Briefly, active material and conductive carbon additives may be combined with polyvinylidene fluoride (PVDF) binder dissolved in N-Methylpyrrolidone (NMP) solvent using vortex milling and planetary mixing to yield a homogenized slurry to be cast on graphite foil current collector. Electrochemical characterization of these electrodes may be performed in aqueous KOH electrolyte in a beaker (i.e., a flooded cell) by using cyclic voltammetry to assess thermodynamic reversibility and by using galvanostatic cycling to assess charge storage capacity and retention thereof. The electrolytes used may contain various concentrations of KOH that help characterize each material's selectivity toward proton intercalation versus K⁺ intercalation, as electrode potential versus Hg/HgO is invariant with KOH concentration if the material of interest intercalates protons with perfect selectivity. Further, these electrodes may also be characterized in electrolytes that simulate the solutions expected during CO₂ capture by also including K₂CO₃ and KHCO₃ in solution with KOH to produce electrolytes that contain CO₃²⁻and HCO₃⁻ in addition to K⁺ and OH⁻.

Flow of electrolyte through electrodes (rather than by electrodes) may produce high thermodynamic energy efficiency and rate capability. However, high electrode loading is needed to facilitate increased ion removal (and later increased CO₂ absorption). Therefore, in various embodiments, crack-free (or near crack-free) electrodes may be fabricated with varied mass loading by using wet-phase inversion of cast electrode slurries. Subsequently, calendaring may be used to densify electrodes to a thickness commensurate for use in flow cell tests or implementations. The tradeoffs between electrode transport properties (porosity, tortuosity, and hydraulic permeability) and electrode loading may be characterized using AC/DC electrochemical and fluidic characterization techniques.

FIG. 2E shows graphical representations that illustrate total gas pressure for a proton intercalation material having certain potential versus the corresponding reversible hydrogen electrode (RHE) and reversible oxygen electrode (ROE) in accordance with various aspects described herein. Here, values of potential are shown for AB₅-type alloys LnNi_{5-y-x}M1_{y}M2ₓ (Ln: rare-earth metal or mixture thereof, M1: transition metal, and M2: group 3A and 4A metals), MgNi, MgTi, TiNi, γ-MnO₂, and NiOOH proton intercalation reactions. As illustrated, proton intercalation material may be composed of an AB5-type alloy that stabilizes the proton intercalation reaction over hydrogen evolution, which can benefit the overall function of the CO₂ capture process. Relative to what is shown in FIGS. 2C and 2D, therefore, a rare earth element, such as Ln, may be used in addition to, or as a substitute for, La and/or one or more transition metals M1, M2 may be used in addition to, or as a substitute for, Ni.

To recap, an exemplary electrochemical pH-swing CO₂ capture process may be provided using materials commonly employed in alkaline batteries, such as the NiMH battery and the Zn/MnO₂ battery. To facilitate their efficient use in electrochemical CO₂ capture will require that the competing reactions of H₂ and O₂ gas evolution (and recombination) be inactive over the potential range in which proton intercalation occurs. The quantification of the gas pressure produced as a function of electrode potential based on equilibrium thermodynamics shown in FIG. 2E (where RHE and ROE are respectively the reversible H₂ and O₂ electrodes at standard pressure, and where gas pressure is directly proportional to Faradaic efficiency loss, and thus minimized gas pressure is desired to maximize energy efficiency during electrochemical cycling) highlights exemplary proton intercalation electrode materials based on electrode potential, including MnO₂ and LnNi_{5-y-x}M1_{y}M2ₓ alloy hydrides. Here, the use of Bi₂O₃ additives with MnO₂ is expected to enhance capacity retention over the MnO₂ used conventionally in alkaline primary batteries. While this suggests that conventional forms of the negative (LaNi₅) and positive (NiOOH) electrodes of the ubiquitous NiMH battery are respectively prone to H₂ and O₂ gas evolution during cycling, kinetic and thermodynamic strategies may be employed to suppress gas evolution by modifying such materials. Specifically, knowledge of AB₅-type metal hydrides used previously for H₂ gas storage may be leveraged to advance electrode materials for efficient alkaline DAC. While the canonical AB₅-type alloy LaNi₅ possesses plateau pressure in excess of 1 bar at room temperature, the logarithm of plateau pressure at a given temperature has been shown to decrease linearly with increasing unit cell volume of the corresponding alloy. Accordingly, Ni may be substituted with other transition metals (e.g., Mn or Co) or with group 3A (e.g., Al, Ga, or In) and 4A (e.g., Ge, Sn, or Pb) to suppress hydriding plateau pressure to facilitate electrochemical proton intercalation for CO₂ capture with high Faradaic efficiency. Notably, the substitution of Ni in LaNi₅ with Mn and Al has yielded similar H₂ storage capacities to LaNi₅ with respective plateau pressures of ˜0.01 bar (LaNi₄Mn) and ˜0.001 bar (LaNi₄Al) at room temperature, making them ideal candidates for an alkaline proton-intercalation based CO₂ capture system. In one or more embodiments, La may be substituted with a specific rare-earth metal (Ln) either to facilitate material stabilization, corrosion inhibition, or enhancement of electrochemical kinetics. In addition, mixed rare earth metals, namely misch metals, may be used as economical versions of the corresponding single-Ln alloys, owing to the relatively high cost to extract pure rare earth metals in refining processes. In addition, other potential hydride chemistries may alternatively be used. Reduced operating temperature may be used as an alternative means to suppress hydrogen plateau pressure by exploiting the van't Hoff relation for hydrides. That is, hydrogen plateau pressure decreases with decreasing temperature for hydriding reactions with negative heat of formation.

FIG. 2F is a top view (B) of an example cell showing valve locations, detailed views of (C) the inlet region of the cell showing symmetric intercalation electrodes sandwiching an ion exchange membrane and (D) valve switching actions, as well as a depiction (E) of the time sequence of cell voltage and salt concentration used to conduct one complete cycle using inset diagrams together with the timing of valve and current switching events controlled automatically, in accordance with various aspects described herein. PC, OC, and NC respectively denote positive current, open circuit, and negative current conditions. The custom-designed flow cell shown may be operated to force flow through porous electrodes containing proton (or other) intercalation materials, recirculate electrolytes from storage tanks using an automated fluid control circuit, and measure ion conductivity in solution at cell inlets and outlets. In one or more embodiments, the electrodes used in this system may sandwich a Nafion cation exchange membrane (CEM) to block the transfer of hydroxide, carbonate, and bicarbonate anions between electrodes. Different methods may be used to pre-charge the electrodes either with both electrodes at a common state-of-charge or with one electrode at low state-of-charge and the other at high state-of-charge. The first such method may involve using flooded-cell cycling, whereas the second such method may involve using in situ constant potentiostatic holds. In certain embodiments, custom reservoirs may be designed (and 3D printed or produced in any other suitable manner) to seal outside gas from the working electrolyte contained within the system. In various embodiments, the cell may be integrated with contactors (discussed below with respect to FIG. 2G) configured to induce CO₂ mass transfer between gas and liquid phases. As part of assessing energy consumption and CO₂ removal rates using different electrodes, CO₂ may be incrementally introduced into a high-pH solution (or a solution super-saturated in dissolved inorganic carbon (DIC)), while simultaneously releasing CO₂ from a low-pH solution (or a solution under-saturated in DIC). One or more system models may be developed to analyze the concentrations of K⁺, OH⁻, CO₂, HCO₃⁻; and/or CO₃²⁻within liquid phases and of CO₂ and carrier gas within gas phases. A lumped approach may be used to model each component of the system including influx and outflux due to fluid flow and interfacial mass transfer. As a result, the model may be used to predict process productivity and energy consumption versus the operating conditions used, including electrical current and flow rates.

In one or more embodiments, the example cell shown in FIG. 2F may correspond to the system 200. Alternatively, the example cell may correspond to any other cell system described herein (whether symmetric or asymmetric), in which case the valve implementation may be adapted as needed to facilitate cycling. It is to be understood and appreciated that the particular valve mechanism shown in FIG. 2F is merely exemplary. For instance, in various embodiments, mechanisms other than the pinching mechanism shown may be employed for valve switching purposes. In any case, valves may be employed with any cell configuration described herein to facilitate CO₂ capture.

FIG. 2G is a schematic of an exemplary, non-limiting integrated direct-air CO₂ capture system facilitated by an alkaline electrochemical pH-swing process using recirculating operation within an electrochemical cell, in accordance with various aspects described herein. Fluid handling and sensing instruments are indicated by [symbol] (pumps 240p), PR (pressure regulators 240r), FM (flow meters 240f), GA (gas analyzers 240g), and pH (pH sensors 240h) symbols. In exemplary embodiments, the system 240 may be configured to flow high-pH and low-pH solutions into hydrophobic membrane contactors respectively for CO₂ capture and release by recirculating solution from pH-controlled reservoirs through flow loops connected to an electrochemical deionization apparatus. Solution flow loops may include pH sensors in their respective reservoirs to enable continuous monitoring of pH as a function of time, in addition to measurements of ionic conductivity with time. Hydrophobic contactor membrane modules may be used that are sized for (1) ambient air flow with about 400 ppm CO₂ gas flow in contact with high-pH solution for CO₂ absorption and (2) pure CO₂ flow in contact with low-pH solution for CO₂ release. Different sizing of contactors and their effects on CO₂ flux of CO₂ mass transfer resistance in solution, gas, and membrane phases may be analyzed. Carrier gas with prescribed levels of CO₂ may be used with appropriate pressure regulation to flow gas into the CO₂ capture contactor, while pure carrier gas with pressure regulation may be used to extract CO₂ from the CO₂ release contactor. While in its practical use for CO₂ capture a carrier gas may or may not be used, the carrier gas used here enables us to characterize process performance using minimal instrumentation. Both such gas streams may be instrumented with flow meters and nondispersive infrared CO₂ gas analyzers to determine process productivity and selectivity, respectively. The system may be plumbed with appropriate valves and tubes to reduce or minimize the internal volume of gas to increase or maximize process performance. Real-time data may be acquired from the respective sensors.

The integrated system may be variously operated to quantify the tradeoffs at fixed current and flow rates between the extent of pH swing and the productivity rate of CO₂ removal/release and CO₂-specific energy consumption. Time resolved measurements of voltage, pH, and CO₂ partial pressure enable us to isolate the effects of pH swing within the electrochemical sub-system from the mass transfer limitations occurring within membrane contactors. After such characterization is performed, flow rates and current may be varied to thoroughly characterize system response to operating condition variations. Different electrode chemistries may be characterized using this platform. Different carrier gases may be tested to characterize CO₂ capture performance in pure Ar, N₂, and O₂ as well as mixtures of N₂ and O₂ that are representative of air. Thus, electrochemical properties may be established for benchmark electrode materials, including potential and charge capacity to predict expected CO₂ storage capacity relative to targets (e.g., 2 mmol_{CO2}/g→50-100 mAh/g). In various embodiments, the system for the enclosed electrochemical pH-swing apparatus may be provided, which may also be used with MnO₂ and other electrode materials.

In some embodiments, a pre-charging protocol, improved/optimized operating conditions, and the pH-swing capacity and energy consumption using MnO₂ electrodes may all be determined, targeting a KOH concentration change of at least 100 mM at pH at parity with certain concentration changes. A lead material may be identified for pH-swing system testing among MnO₂ composite and LaNi₅ alloyed materials based on factors of charge storage capacity, capacity retention, ion selectivity, and coulombic efficiency. Improved or optimized operating conditions for the integrated CO₂ capture system using MnO₂ electrodes may be determined. An integrated system with MnO₂ electrodes and/or electrodes composed of other materials may be used (e.g., in an enclosed system) with feed CO₂ concentrations ranging between 400 ppm and 100%. Electrochemical characterization of MnO₂ polymorphs and de-catalyzed NiOOH may also be made.

In one or more embodiments, the example cell shown in FIG. 2G may correspond to the system 200. Alternatively, the example cell may correspond to any other cell system described herein (whether symmetric or asymmetric), in which case the recirculation system may be adapted as needed to facilitate cycling for CO₂ capture. It is to be understood and appreciated that, although FIG. 2G does not show valves for controlling flow, the CO₂ capture system may employ one or more valves at the inlet and outlet of the positive electrode and one or more valves at the inlet and outlet of the negative electrode for controlling whether CO₂-rich or CO₂-deficient solution is permitted to flow into/through/by the chambers or electrodes. Here, in a symmetric configuration, the production and flow of a high pH solution may be simultaneous with that of a low pH solution. In contrast, in an asymmetric configuration (e.g., such as that described above with respect to FIG. 2B), the plumbing may be adapted to facilitate changes in direction of flow in accordance with timed staging, since only one stream (either high pH solution or low pH solution) is produced or flows in a given cycle.

It is further to be understood and appreciated that the number and arrangement of components, devices, etc. shown in each of FIGS. 2F and 2G are provided as an example. In practice, the cell(s)/system(s) of FIGS. 2F and 2G may include additional components, devices, etc., fewer components, devices, etc., different components, devices, etc., or differently arranged components, devices, etc. than those shown in FIGS. 2F and 2G. Additionally, or alternatively, a set of components, devices, etc. (e.g., one or more components, devices, etc.) of the cell(s)/system(s) of FIGS. 2F and 2G may perform one or more functions described as being performed by another set of components, devices, etc. of the cell(s)/system(s).

Symmetric proton-intercalation cells and asymmetric proton intercalation/alkali-ion intercalation cells have been described above with respect to FIGS. 2A and 2B. In one or more embodiments, symmetric alkali-intercalation cells may be provided for CO₂ capture. FIG. 2H is a schematic of an exemplary, non-limiting embodiment of an electrochemical CO₂ capture cell 250 using symmetric alkali (ne earth)-ion intercalation electrodes that sandwich one of a variety of different types of anion transmissive separators (where IHC represents an intercalation host compound), in accordance with various aspects described herein. The term symmetric refers to the use of two alkali-ion intercalation electrodes with opposite state-of-charge arranged in series electrically, while sandwiching an anion selective separator. Some example types of separators are shown by reference number 250s. Anion-exchange membranes (AEMs) that select toward hydroxide, carbonate, bicarbonate, or a mixture thereof can be used as the anion transmissive separator. Alternatively, a porous diaphragm allowing for the transmission of hydroxide, carbonate, and/or bicarbonate can be used as a separator, provided that the diaphragm is sufficiently thick (e.g., has a thickness that is larger than a threshold) to provide sufficient (e.g., at least a minimum) impedance to diffusive crossover of oppositely charged cations. The use of a diaphragm in place of an AEM may reduce the capital cost of the system, albeit at the cost of efficiency loss stemming from the transmission of alkali cations between electrodes. When a separator is used that provides substantial selectivity toward hydroxide over other anions and cations (e.g., a selectivity toward hydroxide that is greater than a selectivity toward any other anion or cation by a threshold amount), the aqueous flows that are produced through the respective electrodes may experience substantial pH shifts, enabling the generation of one flow that is available for subsequent capture of CO₂ due to its increased pH and the generation of another flow that is available for subsequent release of CO₂ due to its decreased pH. When a separator is used that substantially favors the transmission of carbonate or bicarbonate anions, fluid in the respective electrodes is expected to experience less significant changes in pH. Nonetheless, the effect of transmitting such anions across the separator may cause one flow to become super-saturated in dissolved inorganic carbon (DIC) and the other flow to become under-saturated in DIC. In other words, a pH swing is not necessarily essential to the functioning of this cell for CO₂ capture. Furthermore, the electrodes used in cell 250 may intercalate alkaline-earth cations instead of or in addition to alkali cations, a property which may be beneficial in the context of ocean carbon capture, for instance.

FIG. 2I is a schematic of an exemplary, non-limiting embodiment of an electrochemical CO₂ capture cell 260 using one alkali (ne earth)-ion intercalation electrode and one electrode that intercalates carbonate and/or bicarbonate while having a separator that is omni-transmissive (where IHC represents an intercalation host compound), in accordance with various aspects described herein. In exemplary embodiments, this cell configuration 260 operates using a two-stage process, wherein the first stage 260a under-saturates DIC in solution by capturing alkali (ne earth) cations and (bi)carbonate anions simultaneously into intercalation host compounds (IHCs) designed or selected for the ionic species of interest. Examples of feasible IHCs for alkali (ne earth) cations include, but are not limited to, those already described herein for other symmetric and asymmetric cells using alkali-ion IHCs. An example material class for (bi)carbonate absorption or adsorption includes quinone-based redox-active polymers that undergo reversible carboxylation. Here, under-saturation is principally achieved not by changing pH of the flow but instead by decreasing DIC while maintaining pH roughly constant. As a result, the flow produced during this stage is readily available for subsequent capture of CO₂. Once the capacity of the cell is exhausted and after current is switched, a second stage 260b may begin during which alkali (ne earth) cations and (bi)carbonate anions are released from the IHCs back into solution to cause that solution to become supersaturated in CO₂.

FIG. 2J is a schematic of an exemplary, non-limiting embodiment of an electrochemical CO₂ capture cell 270 using symmetric (bi)carbonate-ion intercalation electrodes that sandwich different types of cation transmissive separators (where IHC represents an intercalation host compound), in accordance with various aspects described herein. Here, a cation exchange membrane (CEM) that is selective toward alkali and/or alkaline-earth cations may be used or, alternatively, a porous diaphragm with sufficient (e.g., at least a minimum) impedance to diffusion of anions across it may be used. Some example types of separators are shown by reference number 270s. The use of a diaphragm in place of a CEM may reduce the capital cost of the system, albeit at the cost of efficiency loss stemming from the transmission of anions between electrodes. In either case, one flow may be generated with under-saturated DIC concentration, along with another flow that is generated with super-saturated DIC concentration.

It is to be understood and appreciated that, in any of the cell configurations discussed herein (e.g., with respect to FIGS. 2A, 2B, 2F, 2G, 2H, 2I, and/or 2J), there may be chambers through which flow may occur, either arranged behind the electrodes or in between the electrodes and any relevant separator. Alternatively, the electrolyte solution may flow through a given electrode itself (e.g., in a case where the electrode is a patterned electrode with flow channels integrated or embedded therein) or via a flow field abutting the electrode. Any combinations of these implementations may be used in any of the cell configurations described herein. As an example, any electrode described herein may correspond to any electrode described in co-pending U.S. patent application Ser. No. 17/980,017, entitled “FLOW CHANNELS FOR OPTIMAL OR IMPROVED DELIVERY OF FLUID TO POROUS ELECTROCHEMICAL/CHEMICAL MEDIA,” filed on Nov. 3, 2022 and co-pending U.S. patent application Ser. No. 17/980,023, entitled “HIERARCHICAL NETWORKS FOR OPTIMAL OR IMPROVED DELIVERY OF FLUID TO POROUS ELECTROCHEMICAL/CHEMICAL MEDIA,” filed on Nov. 3, 2022, which are both hereby incorporated by reference herein in their entireties.

In certain embodiments, a symmetric cell architecture that employs alkali cation intercalation materials on both sides of the cell may employ either a non-selective separator, an anion-exchange membrane, or a carbonate/bicarbonate blocking membrane between electrodes.

In exemplary embodiments, any of the systems 200, 230, 240, 250, 260, and 270 may be configured to facilitate sequestration or valorization of captured CO₂ via carbonate mineralization with alkaline earths (AE). For instance, in certain embodiments, the captured carbon can be mineralized to solid carbon minerals and returned underground for long-term storage or utilized as building materials.

As an example, the ability to concentrate OH⁻ and thereby generate CO₃²⁻ ions by simultaneous dissolution of gaseous CO₂ (i.e., CO₂(g)+2OH⁻→CO₃²⁻+H₂O), as provided by embodiments of pH swing cells described herein, presents synergistic opportunities to sequester CO₂ and leverage industrial waste streams to create valorized products.

In various embodiments, any of the systems 200, 230, 240, 250, 260, and 270 can be integrated with, or otherwise operably coupled to, industrial waste streams to sequester CO₂ and valorize it via mineralization of AE carbonates (e.g., AE oxide, chloride, and/or sulphate wastes) that are sparingly soluble and possess value as building materials. This process can, for example, “close the loop” on OH⁻ consumption during mineralization by generating it in situ. This is in contrast to existing chemical mineralization processes that require a continuous supply of caustic reagents. While the facile conversion of AE oxides to their corresponding hydroxides will not impact the balance of dissolved species from cycle-to-cycle, the lack of participation of chloride and sulphate in CO₂ mineralization may result in their transient accumulation. Thus, in certain embodiments, the system may be operably coupled to a downstream electrochemical desalination process for effecting removal of any excess chloride and sulphate salts.

Generation of OH⁻ in situ for CO₂ capture and mineralization of the captured CO₂ via mixing of caustic solutions with alkaline-earth waste from steel, cement, or desalination industries to generate MgCO₃, CaCO₃, and/or the like (which are highly stabile and may have value as building materials) also improves over conventional chlor-alkali processes that seek to mineralize CO₂, since such processes must expend energy to cogenerate Cl₂ and H₂ gases.

In one or more embodiments, as an alternative to providing a lower pH alkaline electrolyte solution (resulting, for example, from an electrode of a symmetric/asymmetric cell (e.g., system 200/230) undergoing oxidation as part of a cycle) to a degasser to yield CO₂ in pure gas form, the alkaline electrolyte solution can include, dissolved therein, alkaline earths (e.g., magnesium (such as MgCL₂), calcium (such as CaCL₂), or other alkaline earth salts), water from a desalination brine (e.g., that is slightly basic), or the like. In these embodiments, effecting an electrochemical pH swing process to absorb CO₂, and subsequently decreasing the pH of a resulting CO₂-rich solution, can drive reactions of the alkaline earths with the captured CO₂ to precipitate alkaline earth carbonates as minerals. The same or similar alkaline electrolyte solution(s) may be used in symmetric/asymmetric cell configurations described herein that produce solutions that are super-saturated and under-saturated in DIC.

In certain embodiments, any of the systems 200, 230, 240, 250, 260, and 270 may provide open access to alkaline electrolyte solution(s) for injection or refilling of alkaline earths (e.g., from a supply source, a waste stream, etc.) during, or in between, cycling.

In some embodiments, any of the systems 200, 230, 240, 250, 260, and 270 may be configured to inject or add, at an output of a contactor, alkaline earths into an alkaline electrolyte solution containing captured CO₂, which allows for precipitation of solid carbonate minerals.

In one or more embodiments, one or more of the systems 200, 230, 240, 250, 260, and 270 may be configured for ocean-based carbon capture, where CO₂ dissolved as carbonate and/or bicarbonate in seawater may be directly captured and released or sequestered (i.e., rather than capture of CO₂ in the gas phase). Thus, in various embodiments, the electrolyte solution(s) that flow through such a system may include one or more synthesized aqueous alkaline electrolyte solutions or one or more naturally occurring solutions.

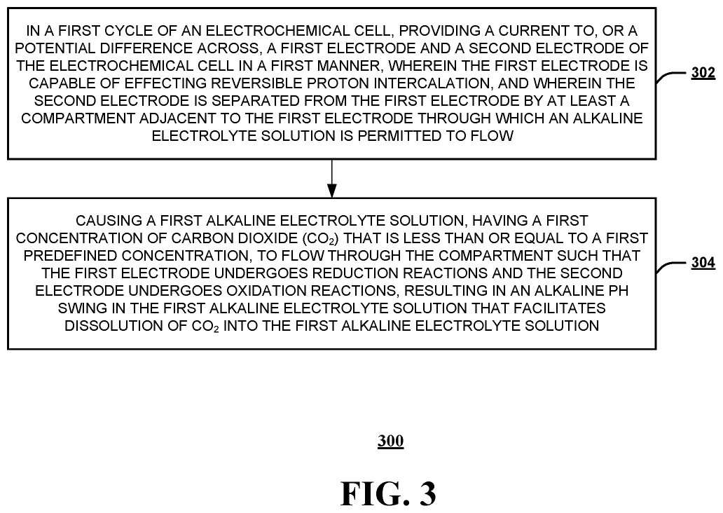

FIG. 3 depicts an illustrative embodiment of a method 300 in accordance with various aspects described herein. In certain embodiments, the method may include steps that are similar to or the same as aspects described above with respect to FIGS. 2A and/or 2B.

At 302, the method can include, in a first cycle of an electrochemical cell, providing a current to, or a potential difference across, a first electrode and a second electrode of the electrochemical cell in a first manner, wherein the first electrode is capable of effecting reversible proton intercalation, and wherein the second electrode is separated from the first electrode by at least a compartment adjacent to the first electrode through which an alkaline electrolyte solution is permitted to flow.

At 304, the method can include causing a first alkaline electrolyte solution, having a first concentration of carbon dioxide (CO₂) that is less than or equal to a first predefined concentration, to flow through the compartment such that the first electrode undergoes reduction reactions and the second electrode undergoes oxidation reactions, resulting in an alkaline pH swing in the first alkaline electrolyte solution that facilitates dissolution of CO₂ into the first alkaline electrolyte solution.

In various embodiments, the method can further include, in a second cycle of the electrochemical cell, providing a current to, or a potential difference across, the first electrode and the second electrode in a second manner, and causing a second alkaline electrolyte solution, having a second concentration of CO₂ that is greater than or equal to a second predefined concentration, to flow through the compartment such that the first electrode undergoes oxidation reactions and the second electrode undergoes reduction reactions, resulting in an alkaline pH swing in the second alkaline electrolyte solution that facilitates liberation of CO₂ from the second alkaline electrolyte solution. In some embodiments, the providing in the first manner may include providing a first potential difference across the first and second electrodes, and the providing in the second manner may include providing a second potential difference (e.g., by reversing the polarity and/or increasing or decreasing the potential difference) across the first and second electrodes. In alternate embodiments, the providing in the first manner may include applying a constant (e.g., positive) current, and the providing in the second manner may include applying a constant (e.g., negative) current.

In various embodiments, the electrochemical cell may further comprise a cation exchange membrane (CEM) disposed between the first electrode and the second electrode, wherein the second electrode may be capable of effecting reversible proton intercalation, thereby providing a symmetric cell configuration.

In various embodiments, the second electrode may comprise an alkali cation intercalation electrode, thereby providing an asymmetric cell configuration. In some of these embodiments, the electrochemical cell may lack an ion exchange membrane.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Further, the functions of proton intercalation electrodes may be similarly or equivalently provided or facilitated by hydroxide intercalation electrodes. Thus, it is to be understood and appreciated that some or all of the embodiments or implementations described herein involving the use of proton intercalation electrode(s) may additionally, or alternatively, employ hydroxide intercalation electrode(s).

It is also to be understood and appreciated that, one of more of the various drawing figures are described herein as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein.

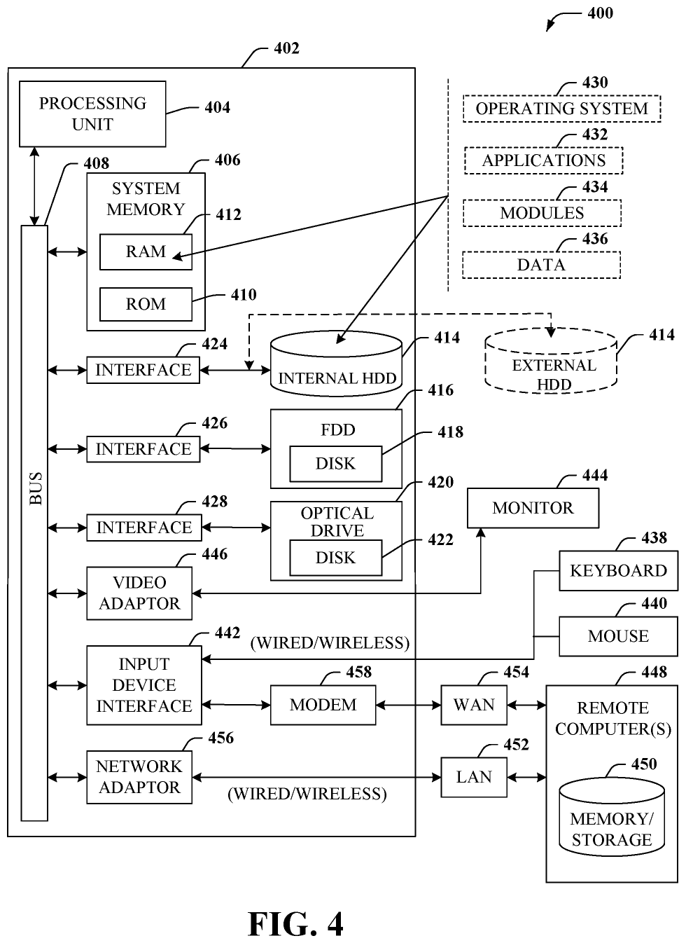

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 with which various embodiments of the subject disclosure can be implemented. Various embodiments can be implemented via computer-executable instructions that can run on one or more computers, and/or in combination with other program modules and/or as a combination of hardware and software. For example, computing environment 400 can facilitate, in whole or in part, capturing and/or mineralization of CO₂ (e.g., as described herein with respect to at least FIGS. 2A and 2B).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits, such as an application specific integrated circuit, digital logic circuit, state machine, programmable gate array, or other circuit that processes input signals or data and that produces output signals or data in response thereto. It should be noted that any functions and features described herein in association with the operation of a processor could likewise be performed by a processing circuit.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information, such as computer-readable instructions, program modules, structured data, or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules, or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared, and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM, such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416 (e.g., to read from or write to a removable diskette 418), and an optical disk drive 420 (e.g., for reading a CD-ROM disk 422 or to read from or write to other high capacity optical media such as the DVD). The HDD 414, magnetic FDD 416, and optical disk drive 420 can be connected to the system bus 408 by a hard disk drive interface 424, a magnetic disk drive interface 426, and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434, and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen, or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device, or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402, or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from various locations, without wires. Wi-Fi is a wireless technology similar to that used in a cell phone that enables such devices, e.g., computers, to send and receive data indoors and out: anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

Any use of the terms “first,” “second,” and so forth, in the claims, unless otherwise clear by context, is for clarity only and doesn't otherwise indicate or imply any order in time. For instance, “a first determination,” “a second determination,” and “a third determination” does not indicate or imply that the first determination is to be made before the second determination, or vice versa, etc.

While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A: X employs B: or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In the subject disclosure, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that certain aspects of the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network: however, some if not all aspects of the subject disclosure can be practiced on stand-alone computers. In a distributed computing environment, program modules can be located in both local and remote memory storage devices.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components with or without mechanical parts, where the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

As employed herein, the term “processor” can refer to substantially any computing processing unit or device comprising, but not limited to comprising, single-core processors: single-processors with software multithread execution capability: multi-core processors: multi-core processors with software multithread execution capability: multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative (rather than in a restrictive) sense.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An electrochemical apparatus, comprising:
a pair of electrodes each composed of an intercalation host compound (IHC);
a separator disposed between the pair of electrodes; and
a controller configured to control cycling of the electrochemical apparatus, wherein the pair of electrodes is configured to undergo, during the cycling, reduction-oxidation (redox) reactions in electrolyte solutions that facilitate capturing of carbon dioxide (CO₂) and release of captured CO₂.

2. The electrochemical apparatus of claim 1, wherein the IHC of each electrode in the pair of electrodes is capable of reversible proton intercalation or reversible hydroxide intercalation, and wherein the separator comprises a cation exchange membrane (CEM) or a diaphragm operative to facilitate power of hydrogen (pH) swings in the electrolyte solutions for the capturing of CO₂ and the release of captured CO₂.

3. The electrochemical apparatus of claim 1, wherein the IHC of at least one electrode in the pair of electrodes comprises:
nickel oxyhydroxide (NiOOH);
nickel (II) hydroxide (Ni(OH)₂);
manganese (III) oxyhydroxide (MnOOH);
gamma-manganese dioxide (γ-MnO₂);
metal hydride;
lanthanum nickel (LaNi₅);
misch metal nickel;
one or more alloys in a ternary system that includes magnesium (Mg), nickel (Ni), and titanium (Ti);
one or more alloys that include a rare-earth metal (Ln), a transition metal, and a group 3A or 4A metal; or
any combination thereof.

4. The electrochemical apparatus of claim 1, wherein the IHC of at least one electrode in the pair of electrodes has a potential for proton intercalation that is within a first threshold from an oxygen gas evolution potential and that is within a second threshold from a hydrogen gas evolution potential.

5. The electrochemical apparatus of claim 1, wherein the IHC of each electrode in the pair of electrodes is capable of reversible alkali-ion intercalation or reversible alkaline earth-ion intercalation, and wherein the separator comprises an anion exchange membrane (AEM) or a diaphragm that is selective toward hydroxide, carbonate, bicarbonate, or a mixture thereof.

6. The electrochemical apparatus of claim 5, wherein the separator is configured to be selective toward hydroxide over other anions or cations such that the cycling results in power of hydrogen (pH) swings in the electrolyte solutions that facilitate the capturing of CO₂ and the release of captured CO₂.

7. The electrochemical apparatus of claim 5, wherein the separator is configured to be selective toward carbonate or bicarbonate anions over other anions or cations such that the cycling results in super-saturation in dissolved inorganic carbon (DIC) in one of the electrolyte solutions and under-saturation in DIC in another one of the electrolyte solutions.

8. The electrochemical apparatus of claim 1, wherein the IHC of each electrode in the pair of electrodes is capable of reversible carbonate-ion intercalation or reversible bicarbonate-ion intercalation, and wherein the separator comprises a cation exchange membrane (CEM) or a diaphragm that is selective toward alkali cations, alkaline-earth cations, or a mixture thereof such that the cycling results in super-saturation in dissolved inorganic carbon (DIC) in one of the electrolyte solutions and under-saturation in DIC in another one of the electrolyte solutions.

9. The electrochemical apparatus of claim 1, wherein flow of one or more of the electrolyte solutions is via:
one or more chambers adjacent to one or more electrodes in the pair of electrodes;
one or more flow fields abutting one or more electrodes in the pair of electrodes;
flow channels embedded or formed in one or more electrodes in the pair of electrodes; or
any combination thereof.

10. The electrochemical apparatus of claim 1, wherein inlets and outlets of the pair of electrodes are arranged to couple, via one or more valves, to a contactor for the capturing of CO₂ and a degasser for the release of captured CO₂.

11. The electrochemical apparatus of claim 1, wherein the electrolyte solutions comprise one or more synthesized aqueous alkaline electrolyte solutions or one or more naturally occurring solutions.

12. The electrochemical apparatus of claim 1, wherein the electrochemical apparatus is operably coupled with a source of alkaline earth materials, and wherein the controller is further configured to cause portions of the alkaline earth materials to be added to an electrolyte solution that comprises captured CO₂ so as to facilitate carbon sequestration or valorization.

13. The electrochemical apparatus of claim 1, wherein a first electrolyte solution of the electrolyte solutions comprises alkaline earth materials that are operative to react with the captured CO₂ to form solid carbonate minerals.

14. An electrochemical cell, comprising:
a first electrode composed of a first intercalation host compound (IHC);
a second electrode composed of a second IHC; and
a control circuit configured to manage cycling of the electrochemical cell, wherein the first electrode and the second electrode undergo, in various stages of the cycling, reduction-oxidation (redox) reactions in an alkaline electrolyte solution that facilitate dissolution of carbon dioxide (CO₂) and liberation of captured CO₂.

15. The electrochemical cell of claim 14, wherein the first IHC is capable of proton intercalation, wherein the second IHC is capable of alkali cation intercalation, wherein the electrochemical cell lacks an ion exchange membrane, and wherein the various stages of the cycling result in power of hydrogen (pH) swings in the alkaline electrolyte solution that facilitate the dissolution of CO₂ and the liberation of captured CO₂.

16. The electrochemical cell of claim 15, wherein the second IHC comprises a one or more inorganic redox-active materials or one or more polymeric redox-active materials.

17. The electrochemical cell of claim 14, wherein the first IHC is capable of alkali-ion intercalation or alkaline earth-ion intercalation, wherein the second IHC is capable of carbonate-ion intercalation or bicarbonate-ion intercalation, wherein the electrochemical cell further comprises an omni-transmissive separator, and wherein the various stages of the cycling comprise one stage in which there is super-saturation in dissolved inorganic carbon (DIC) in the alkaline electrolyte solution and another stage in which there is under-saturation in DIC in the alkaline electrolyte solution.

18. A method for operating an electrochemical cell having a first electrode and a second electrode, the method comprising, in a first cycle of the electrochemical cell:
providing a current to, or a potential difference across, the first electrode and the second electrode; and
causing a first alkaline electrolyte solution to flow through at least a portion of the electrochemical cell such that the first electrode and the second electrode undergo reactions, resulting in under-saturation in dissolved inorganic carbon (DIC) in the first alkaline electrolyte solution or resulting in an alkaline power of hydrogen (pH) swing in the first alkaline electrolyte solution that facilitates dissolution of carbon dioxide (CO₂) into the first alkaline electrolyte solution.

19. The method of claim 18, further comprising, in a second cycle of the electrochemical cell:
providing a current to, or a potential difference across, the first electrode and the second electrode; and
causing a second alkaline electrolyte solution to flow through at least a portion of the electrochemical cell such that the first electrode and the second electrode undergo reactions, resulting in super-saturation in DIC in the second alkaline electrolyte solution or resulting in an alkaline pH swing in the second alkaline electrolyte solution that facilitates liberation of CO₂ from the second alkaline electrolyte solution.

20. The method of claim 18, wherein the electrochemical cell comprises:
a symmetric configuration in which each of the first electrode and the second electrode is composed of an intercalation host compound (IHC) that is capable of proton intercalation, hydroxide intercalation, alkali-ion intercalation, alkaline earth-ion intercalation, carbonate-ion intercalation, or bicarbonate-ion intercalation; or
an asymmetric configuration in which:
the first electrode is composed of an IHC that is capable of proton intercalation and the second electrode is composed of an IHC that is capable of alkali-ion intercalation or alkaline earth-ion intercalation; or
the first electrode is composed of an IHC that is capable of carbonate-ion intercalation or bicarbonate-ion intercalation and the second electrode is composed of an IHC that is capable of alkali-ion intercalation or alkaline earth-ion intercalation.
